(19) United States
(12) Patent Application Publication
(10) Pub. No.: US 2022/0153122 A1
(43) Pub. Date: May 19, 2022

(54) Transmission Assembly, Powertrain, and Method for Operating Same

(71) Applicant: ZF Friedrichshafen AG, Friedrichshafen (DE)

(72) Inventors: Stefan Beck, Eriskirch (DE); Thomas Martin, Weissensberg (DE); Fabian Kutter, Kressbronn (DE); Matthias Horn, Tettnang (DE); Michael Wechs, Weißensberg (DE); Johannes Kaltenbach, Friedrichshafen (DE); Martin Brehmer, Tettnang (DE); Thomas Kroh, Lindau (DE); Oliver Bayer, Hörbranz (AT); Peter Ziemer, Tettnang (DE); Max Bachmann, Friedrichshafen (DE)

(21) Appl. No.: 17/431,190

(22) PCT Filed: Oct. 15, 2019
(86) PCT No.: PCT/EP2019/077937

§ 371 Date: Aug. 16, 2021

(30) Foreign Application Priority Data
Mar. 5, 2019 (DE) 10 2019 202 970.1

(51) Int. Cl. B60K 6/547; F16H 3/00; F16H 3/091; B60K 6/36; B60K 6/387

(52) U.S. Cl. CPC B60K 6/547; F16H 3/006; F16H 3/091; F16H 2063/025; B60K 6/387; F16H 2200/0047; B60K 6/36

(57) ABSTRACT

A transmission arrangement (16) for a motor vehicle drive train (10), includes a first shaft arrangement (24, 26) and a second shaft arrangement (28), a plurality of engageable gear sets (36, 38, 42, 48, 50), which connect the first shaft arrangement (24, 26) and the second shaft arrangement (28) in order to establish at least one appropriate plurality of gear steps (1-5), and a plurality of at least three gearshift clutches (B, D, C) for engaging at least some (38, 48, 50) of the gear sets (36, 38, 42, 48, 50). Two (B, D) of the three gearshift clutches (B, D, C) form a gearshift clutch assembly (52), which is arranged at one (28) of the shaft arrangements (24, 26; 28). One gearshift clutch (C) of the three gearshift clutches (B, D, C) is arranged at the other shaft arrangement (24, 26) and, with the gearshift clutch assembly (52), is arranged in a gearshift clutch plane (E2). The gear sets (48, 50) associated with the two gearshift clutches (B, D) of the gearshift clutch assembly (52) are arranged on a first axial side (53) of the gearshift clutch plane (E2).

### CROSS-REFERENCE TO RELATED APPLICATIONS

The present application is related and has right of priority to German Patent Application No. 102019202970.1 filed in the German Patent Office on Mar. 5, 2019 and is a nationalization of PCT/EP2019/077937 filed in the European Patent Office on October 15, 2019, both of which are incorporated by reference in their entirety for all purposes.

### FIELD OF THE INVENTION

The present invention relates generally to a transmission arrangement for a motor vehicle drive train, with a first shaft arrangement and a second shaft arrangement, with a plurality of selectively engageable gear sets, which connect the first shaft arrangement and the second shaft arrangement in order to establish at least one appropriate plurality of gear steps, and with a plurality of at least three gearshift clutches for selectively engaging at least some of the gear sets, wherein two of the three gearshift clutches form a gearshift clutch assembly, which is arranged at one of the shaft arrangements.

The present invention further relates generally to a drive train for a motor vehicle, with a dual-clutch assembly, which includes a first clutch and a second clutch, and with a transmission arrangement of the above-described type, wherein the first clutch is associated with a first sub-transmission of the transmission arrangement and wherein the second clutch is associated with a second sub-transmission of the transmission arrangement.

Finally, the present invention relates generally to a method for operating a drive train of this type.

### BACKGROUND

A transmission arrangement of the above-described type is known from document DE 10 2006 036 758 A1. The automated dual-clutch transmission disclosed therein includes two input shafts and at least one output shaft and an unsynchronized gear clutch, wherein associated with each of the input shafts is a separate clutch for connection to the drive shaft of a prime mover and, for connection to the output shaft, a group of gear-step gearwheels, in each case, having different ratios and each including one fixed gear and one idler gear, which is engageable by an associated gear clutch. In order to simplify the configuration and the controllability, the two clutches are designed as unsynchronized dog clutches. Two electric machines, which are alternately drivingly connected to one of the input shafts, are provided as starting and synchronizing means.

Dual-clutch transmissions have represented an alternative to torque converter automatic transmissions for several years. Dual-clutch transmissions have a dual-clutch assembly, which is connectable on the input side to a prime mover such as an internal combustion engine. An output element of a first friction clutch of the clutch assembly is connected to a first input shaft of a first sub-transmission, which is typically associated with the even forward gear steps or with the odd forward gear steps. An output element of a second friction clutch of the dual-clutch assembly is connected to a second input shaft of a second sub-transmission, which is typically associated with the other forward gear steps.

The gear steps associated with the sub-transmissions can generally be engaged and disengaged in an automated manner. During normal operation, one of the clutches of the dual-clutch assembly is engaged. In the other, inactive, sub-transmission, a connecting gear step can then be engaged in advance. A gear change can then be carried out essentially without interruption of tractive force by an overlapping actuation of the two friction clutches.

Motor vehicle transmissions are generally designed either for the front or the rear transverse installation in a motor vehicle, wherein attention is paid, in particular, to a short axial installation length. Alternatively, transmissions are designed for a longitudinal installation in a motor vehicle, wherein attention is paid, in particular, to a radially compact design.

In the front-mounted and rear-mounted transverse transmissions, two countershafts arranged axially parallel are frequently associated with an input shaft arrangement, and so the power flow can take place from the input shaft arrangement either via the one countershaft or via the other countershaft. The countershafts are also designed as output shafts and, in general, are both in engagement with a differential for distributing input power to driven wheels.

A further trend in the field of motor vehicle drive trains is hybridization. In general, this means a prime mover in the form of an internal combustion engine has associated therewith an electric machine, as a further prime mover. Here, a distinction is made between a plurality of different concepts, which each provide a different connection of the electric machine to the transmission. In a typical variant of dual-clutch transmissions, an electric machine is arranged concentrically to an input element of the dual-clutch assembly. In order to be able to utilize the electric machine, in this case, not only for assisting the internal combustion engine, but rather also to be able to set up a purely electric motor-driven operation, the input element of the dual-clutch assembly is generally connected to the internal combustion engine by a separating clutch or an internal combustion engine-decoupling device.

The hybridization of transmissions, with respect to the requirements mentioned at the outset, places high requirements on radial and/or axial installation space.

In the dual-clutch transmission described in DE 10 2006 036 758 A1 mentioned at the outset, an electric machine is associated with each sub-transmission. Moreover, the dual-clutch assembly is formed by two unsynchronized dog clutches. The rotational-speed adaptations necessary for the starting operation and for the synchronization during gear changes are implemented by the electric machines. The unsynchronized dog clutches are combined in a shared clutch block, which has two engagement positions, in which one of the two clutches is engaged in each case, and a neutral position with a completely interrupted power flow. During gear changes in an internal combustion engine-driven operation, a changeover of the clutches of the dual-clutch assembly is always necessary. Moreover, depending on the type of the gear change, one or both electric machine(s) must be actuated for the synchronization and/or for the load transfer. Moreover, the internal combustion engine must always self-synchronize during these types of gear changes.

### SUMMARY OF THE INVENTION

Example aspects of the present invention provides an improved transmission arrangement for a motor vehicle drive train, an improved drive train for a motor vehicle, and an improved method for operating a drive train, wherein, in particular, an axially compact design is to be implemented.

Example aspects of the present invention provide, on the one hand, a transmission arrangement for a motor vehicle drive train, with a first shaft arrangement and a second shaft arrangement, with a plurality of engageable gear sets, which connect the first shaft arrangement and the second shaft arrangement in order to establish at least one appropriate plurality of gear steps, with a plurality of at least three gearshift clutches for engaging at least some of the gear sets, wherein two of the three gearshift clutches form a gearshift clutch assembly, which is arranged at one of the shaft arrangements, wherein one gearshift clutch of the three gearshift clutches is arranged at the other shaft arrangement and is arranged with the gearshift clutch assembly in a gearshift clutch plane, and wherein the gear sets associated with the two gearshift clutches of the gearshift clutch assembly are arranged on a first axial side of the gearshift clutch plane.

Moreover, example aspects of the present invention provide a drive train for a motor vehicle, with a dual-clutch assembly, which includes a first clutch and a second clutch, and with a transmission arrangement of the type according to example aspects of the invention, wherein the first clutch is associated with a first sub-transmission of the transmission arrangement and wherein the second clutch is associated with a second sub-transmission of the transmission arrangement.

Finally, example aspects of the present invention provide a method for operating a drive train of the type according to example aspects of the invention, including, during an internal combustion engine-driven operation or a hybrid operation, utilizing the gear steps of the first sub-transmission by engaging the first clutch of the dual-clutch assembly and utilizing the gear steps of the second sub-transmission by engaging the first clutch and a third clutch, which connects the first sub-transmission and the second sub-transmission.

Due to the measure of actuating two gear sets with a gearshift clutch assembly that is not arranged between the two gear sets, but rather on one axial side thereof, and due to the further measure of arranging a further gearshift clutch assembly, which has at least one gearshift clutch, in a gearshift clutch plane, in which the aforementioned gearshift clutch assembly is arranged, the transmission arrangement can be designed to be axially highly compact.

In general, a gearshift clutch assembly is understood to be an arrangement formed from two gearshift clutches, which are alternately actuatable by one single actuating unit. Moreover, a gearshift clutch assembly generally has a neutral position, in which neither of the two gearshift clutches of the assembly is engaged. A gearshift clutch assembly of this type can also be referred to as a double shift element. A gearshift clutch assembly can also be formed, however, by only one single gearshift clutch, which has an engaged position and a neutral position, and which is also actuatable by a single actuating unit.

Engageable gear sets are understood to be, in the present case, gear sets that include an idler gear and a fixed gear, which are in engagement with each other in an intermeshed manner, and which are engageable by an associated gearshift clutch. In an engaged gear set, the idler gear of that gear set is rotationally fixed to the associated shaft. The gear sets are preferably spur gear trains, which preferably connect one of two input shafts and one single countershaft (output shaft) to each other, in each case.

Associated with each gear set, preferably, is a regular forward gear step, i.e., a fixed ratio. The transmission arrangement preferably does not include a gear set that is associated with a reverse gear step, provided that the transmission arrangement includes an electric machine for providing input power. Travel in reverse is preferably implemented via an electric machine in this case.

Preferably, the transmission arrangement includes five or six gearshift clutches, which are appropriately associated with five or six forward gear steps.

With five or six forward gear steps, an internal combustion engine-driven operation can be implemented across a large speed range. When an electric machine is provided, which can provide input power, travel can take place, if necessary, exclusively in an electric motor-driven manner for very large speed ranges.

The transmission arrangement therefore preferably has only five or six gear set planes. Moreover, the transmission arrangement preferably includes only two gearshift clutch planes.

In one gearshift clutch plane, the gearshift clutch assembly that is arranged on one axial side of two gear sets to be engaged therewith is arranged at one shaft arrangement. Moreover, in the same gearshift clutch plane, a further gearshift clutch assembly, which preferably includes precisely one gearshift clutch, is arranged at the other shaft arrangement.

A further gearshift clutch assembly, which is associated with two further forward gear steps, is preferably arranged in a second gearshift clutch plane. Provided that this further gearshift clutch assembly is also arranged on one axial side of two gear sets, yet another gearshift clutch assembly, which preferably also includes precisely one gearshift clutch, can be arranged at the other shaft arrangement in the same plane.

In other words, it is possible to engage up to six forward gear steps with two gearshift clutch planes. In the case of six forward gear steps, it is also possible, however, to provide three gearshift clutch planes, if necessary.

The transmission arrangement preferably includes only precisely three actuating units, which are associated with gearshift clutch assemblies of the transmission arrangement. This applies, preferably, for the case in which the transmission arrangement has five forward gear steps. Provided that the transmission arrangement has six forward gear steps, the transmission arrangement can also include precisely four actuating units.

For the case in which the transmission arrangement is connected on the input side to a clutch assembly, a single further actuating unit or two further actuating units (for example, in the case of a dual-clutch assembly) can be provided for this clutch assembly.

In one preferred example variant, the order of the elements starting from an input of the transmission arrangement is as follows: gear set for the fourth forward gear step 4, gear set for the second forward gear step 2, gearshift clutch plane with a gearshift clutch assembly for the fourth and second forward gear steps 4 and 2 at one shaft arrangement and a further gearshift clutch assembly at the other shaft arrangement, wherein the further gearshift clutch assembly includes a single gearshift clutch for the third forward gear step 3 (or the fifth forward gear step 5) and, optionally, a third clutch, gear set for the third forward gear step 3 (or fifth forward gear step 5), gear set for the first forward gear step 1, gearshift clutch assembly for the first and fifth forward gear steps 1 and 5 (or first and third forward gear steps 1 and 3), and gear set for the fifth forward gear step 5 (or the third forward gear step 3).

The gearshift clutch assembly for the fourth and second forward gear steps 4 and 2 is preferably arranged at a countershaft, which is designed, in particular, as an output shaft. A gearshift clutch assembly for the first and fifth forward gear steps 1 and 5 (or first and third forward gear steps 1 and 3) is preferably also arranged at this countershaft, although the gearshift clutch assembly for the first and fifth forward gear steps 1 and 5 (or first and third forward gear steps 1 and 3) can also be arranged at the other shaft arrangement, which is preferably an input shaft arrangement. The gearshift clutch assembly, which includes the gearshift clutch for the third forward gear step 3 (or the fifth forward gear step 5) and is arranged in the same gearshift clutch plane as the gearshift clutch assembly for the fourth and second forward gear steps 4 and 2, is preferably arranged at the other shaft arrangement, which is designed, in particular, as an input shaft arrangement.

According to one preferred example embodiment of the transmission arrangement, the gear set that is associated with the gearshift clutch arranged at the other shaft arrangement, is arranged on a second axial side of the gearshift clutch plane.

This gearshift clutch is preferably associated with the third forward gear step 3 (or the fifth forward gear step 5).

Moreover, it is advantageous overall when, of the two gear sets arranged on the first axial side of the gearshift clutch plane, the gear set that is situated axially farther away from the gearshift clutch plane includes an idler gear, which is rotationally fixed to the connecting shaft, at which an idler gear of the gear set is rotatably mounted, which is situated axially closer to the gearshift clutch plane. The connecting shaft can be formed as one piece with the idler gear.

The connecting shaft preferably extends through the idler gear of the gear set situated axially closer to the gearshift clutch plane.

The connecting shaft itself is preferably designed as a hollow shaft and is arranged coaxially to a countershaft, which is designed, in particular, as an output shaft.

In this example embodiment, the gearshift clutch assembly for these two gear sets arranged on the first axial side of the gearshift clutch plane includes a gearshift clutch that faces the first axial side and a gearshift clutch that faces away from the first axial side.

The gearshift clutch that faces the first axial side is preferably associated with the gear set situated axially closer to the gearshift clutch plane. The gearshift clutch facing away from the first axial side of the gearshift clutch plane is preferably associated with the gear set that is situated axially farther away from the gearshift clutch plane.

While, in conventional gearshift clutch assemblies, an actuating unit of the gearshift clutches included therein generally operates in such a way that the individual actuating unit moves a sliding element toward the associated gear set, the above-described gearshift clutch assembly in this example embodiment is unconventional. Here, a sliding element of the gearshift clutch assembly is, in fact, moved toward this gear set in order to engage the gear set situated closer to the gearshift clutch plane. In order to engage the gear set situated farther away from the gearshift clutch plane, the sliding element of this gearshift clutch assembly is moved, however, axially in a direction away from the associated gear set.

According to one further preferred example embodiment, a sliding element of this gearshift clutch assembly is axially displaceably mounted at an axial projection of a fixed gear of the gear set that is arranged on the second axial side of the gearshift clutch plane.

In this way, the mounting of this sliding element can be implemented in a structually favorable manner.

It is particularly preferred when the transmission arrangement includes two sub-transmissions, of which one is preferably associated with odd forward gear steps and, in fact, in particular with the first, third, and fifth forward gear steps 1, 3, and 5. The transmission arrangement in this case preferably includes a second sub-transmission, which is associated, in particular, with the even forward gear steps. The second sub-transmission preferably includes the second and fourth forward gear steps 2 and 4, and, if necessary, can also include a sixth forward gear step.

It is particularly preferred when the first shaft arrangement is an input shaft arrangement with a first input shaft of a first sub-transmission of the transmission arrangement and with a second input shaft, mounted concentrically thereto, of a second sub-transmission, and/or when the second shaft arrangement is a single output shaft, which is arranged axially parallel to the first shaft arrangement (as a countershaft). The first input shaft is preferably designed as an inner shaft and extends from an input of the transmission arrangement in the axial direction through the second sub-transmission to the first sub-transmission, which is preferably arranged at a side of the second sub-transmission axially opposite the transmission input.

Preferably, the output shaft is connected via an output gear set to a power distribution unit, such as a differential.

The input shaft arrangement is preferably situated on a first axis, the output shaft is preferably situated on a second axis, and the power distribution unit is preferably situated on a third axis.

The transmission arrangement is preferably designed for the transverse installation in a motor vehicle and, in fact, in a front of the motor vehicle or in a rear of the vehicle. The axial installation space restrictions arising as a result are overcome particularly well by the transmission arrangement according to example aspects of the invention.

Provided that the gearshift clutch assembly arranged in a gearshift clutch plane with the gearshift clutch assembly associated with the two gear sets includes only the gearshift clutch for engaging one gear set, the transmission arrangement can be operated as a dual-clutch transmission. Here, the input shaft arrangement is connected to a dual-clutch assembly, which is alternately engaged, in order to bring either the first sub-transmission or the second sub-transmission into the power flow. The dual-clutch assembly can include friction clutches. Provided that at least one, preferably two electric machines is/are associated with the transmission arrangement, the clutches of the dual-clutch assembly can also be implemented as form-locking clutches, in particular as dog clutches.

It is particularly preferred, however, when the transmission arrangement includes a third clutch for connecting the first sub-transmission and the second sub-transmission and, in fact, in particular for connecting the first input shaft and the second input shaft. The third clutch preferably forms a further gearshift clutch assembly with the gearshift clutch that is arranged at the other shaft arrangement.

The third clutch is preferably not a clutch of the type that is utilized for establishing a winding-path gear step in the transmission arrangement. This is the case because, during the establishment of a winding-path gear step, two gear sets of each of the two sub-transmissions are generally involved, in order to implement a ratio that is as low as possible or a ratio that is as high as possible, i.e., in order to allow for a high spread of gear ratios of the transmission arrangement. In the present case, however, power is preferably always transmitted only via one gear set either from the first input shaft to the countershaft or from the second input shaft to the countershaft, and so the spread of gear ratios of the transmission arrangement results preferably exclusively due to the ratios of the regular forward gear steps. Consequently, the transmission arrangement can generally operate with a high efficiency.

The drive train equipped with a transmission arrangement of this type makes it possible, due to the provision of the third clutch for connecting the first sub-transmission and the second sub-transmission, for gear changes to be carried out in an internal combustion engine-driven operation or in a hybrid operation without the need to actuate the dual-clutch assembly.

In the internal combustion engine-driven operation or in the hybrid operation, upon implementation of one example embodiment of a method, the one clutch of the one sub-transmission remains engaged for all conditions of this operation, while the other clutch of the dual-clutch assembly remains disengaged during all conditions of this operation. The third clutch remains disengaged or engaged, depending on the gear step.

According to one particularly preferred example embodiment, the transmission arrangement includes a first electric machine, which is connected to the first input shaft, and/or a second electric machine, which is connected to the second input shaft.

As a result, a hybrid transmission arrangement is made available.

With this type of transmission arrangement, the following methods can be preferably carried out:

A method for operating a hybrid drive train, includes, in an internal combustion engine-driven operation, disengaging the third clutch in a gear step of the one sub-transmission, in order to decouple the other sub-transmission and the electric machine associated with the other sub-transmission.

A further method for operating a hybrid drive train includes, in a purely electric motor-driven operation, providing input power of the first electric machine via the first sub-transmission and/or simultaneously providing input power of the second electric machine via the second sub-transmission, wherein a powershift is preferably implemented, in that one of the electric machines maintains the tractive force via the associated sub-transmission, while a gear change is carried out in the other sub-transmission.

In a purely electric motor-driven operation, it is also possible to disengage both clutches of the dual-clutch assembly and engage the third clutch, and so the two electric machines are coupled to each other and, jointly, can provide input power via a single gear step. Alternatively, it is possible, in a purely electric motor-driven operation, to operate the two electric machines in parallel via the particular sub-transmissions of the two electric machines and leave the third clutch disengaged.

The second clutch of the dual-clutch assembly, which is preferably always disengaged in the normal internal combustion engine-driven operation and in the normal hybrid operation, is preferably engaged in a serial operation. In the serial operation, one electric machine operates as a motor and provides electric motor-generated input power for a purely electric motor-driven operation, for example, for an operation in a starting gear step (first gear), in order to drive a vehicle in a “crawler gear”. The other electric machine is operated as a generator and, in fact, driven by the internal combustion engine, in order to charge a vehicle battery. The vehicle battery is preferably the same battery from which the electric machine operating as a motor withdraws power.

In the present case, both electric machines can be utilized as a generator or as a motor in a serial operation.

In the aforementioned crawler gear, the ground speed of the vehicle is generally below a speed, at which the internal combustion engine can be utilized as a prime mover (due to the ratio of the lowest gear step or starting gear step). In order to also be able to permanently establish a low ground speed of this type beyond the maximum capacity of the vehicle battery, the above-described serial operation can be implemented.

In addition, with the hybrid drive train according to example aspects of the invention, it is possible to utilize an electric machine for synchronization during gear changes in an internal combustion engine-driven operation or a hybrid operation, i.e., to assist the internal combustion engine during synchronization with an electric machine. In other words, in the internal combustion engine-driven operation or in the hybrid operation, one of the electric machines is always connected to the internal combustion engine. As a result, a load-point displacement at the internal combustion engine is possible and this electric machine can assist during the closed-loop control of the rotational speed when a shift element, such as a gearshift clutch, must be synchronized. Consequently, the internal combustion engine does not need to synchronize “on its own”, but rather is always “picked up” at the current rotational speed by one of the two electric machines.

Overall, it is possible with the hybrid drive train according to example aspects of the invention to establish at least one of the following operating modes: a purely internal combustion engine-driven operation; a purely electric operation with the first electric machine; and a purely electric operation with bthe second electric machine.

Moreover, a hybrid operation can be established, in which input power is provided by the internal combustion engine and electric motor-generated input power is provided by the first electric machine and/or the second electric machine. The hybrid traveling mode can be a drive mode, although the hybrid traveling mode can also be a mode, in which mechanical input power is at least partially supplied to the electric machines, in order to operate the electric machines as generators for charging a vehicle battery.

Moreover, the hybrid drive train is preferably configured for carrying out a sailing operation, in which, starting from a moderate or high ground speed, the internal combustion engine is decoupled and the ground speed is maintained, for example, by an intermittent operation of one or both electric machine(s). Stationary charging is also possible.

Consequently, the hybrid drive train is operable in all conceivable electric motor-driven, internal combustion engine-driven, or hybrid traveling modes.

The electric machines are preferably arranged axially parallel to the transmission arrangement. Consequently, the longitudinal axes of the electric machines are preferably arranged in parallel, although offset with respect to the input shafts as well as to the countershaft.

Moreover, in one preferred example embodiment, the first electric machine and the second electric machine are identical. This yields cost advantages and stock-control advantages. The two electric machines can then operate practically “equally” within the transmission arrangement and can both be operated alternately as a prime mover and/or as a generator.

It is particularly preferred when the gearshift clutch that forms a further gearshift clutch assembly with the third clutch is associated with the sub-transmission, the associated clutch of which is always engaged in the internal combustion engine-driven operation and in the hybrid operation. Preferably, this gearshift clutch is associated with a gear set of the first sub-transmission, which is associated with the odd forward gear steps. It is particularly preferred when this gear set is associated with the fifth forward gear step 5 or the third forward gear step 3.

In the present case, a connection is understood to mean, in particular, that the two elements to be connected to each other are permanently connected to each other in a rotationally fixed manner. Alternatively or as necessary, the two elements can be connected to each other in a rotationally fixed manner. In the present case, a rotationally fixed connection is understood to mean that the elements connected in this way rotate at a rotational speed proportional to each other, in particular, rotate at the same rotational speed.

According to one further preferred example embodiment, the first clutch of the dual-clutch assembly and/or the second clutch of the dual-clutch assembly and/or the third clutch and/or at least one gearshift clutch of the transmission arrangement are/is designed as a dog clutch, i.e., as a non-synchronized shift element. A dog clutch of this type includes, in particular, no friction elements for synchronizing components to be connected to each other.

Due to the fact that a separate electric machine is preferably associated with each sub-transmission, functions of the synchronization and/or of the load transfer can take place via the electric machines. Accordingly, the above-mentioned clutches can be designed as dog clutches, and so potential for the reduction of the axial and/or radial installation space can result, as well as weight advantages.

In a further example embodiment preferred overall, the first electric machine is connected to the first input shaft via a gear-step gear set of the first sub-transmission and/or the second electric machine is connected to the second input shaft via a gear-step gear set of the second sub-transmission.

In general, it is conceivable to arrange the electric machines coaxially to, for example, the particular input shaft of the sub-transmissions. It is preferred, however, when the electric machines are arranged axially parallel to the input shaft arrangement. The connection to the particular input shaft can then take place via a flexible traction drive mechanism or a gear set. A separate gear set can be provided for this purpose. This can have the advantage of a connection having an optimized ratio. As mentioned above, it is preferred, however, when the connection of the electric machines takes place via particular gear-step gear sets. Weight can be saved as a result. A ratio adaptation can preferably take place in that a machine pinion of the particular electric machine is not directly connected to a gearwheel of the gear-step gear set or is in engagement therewith in an intermeshed manner, but rather that an intermediate gear is intermediately connected, and so the electric machines can be connected to the particular sub-transmissions with an optimized ratio. In particular, the electric machines can be implemented as relatively high-speed machines, which, consequently, can be designed to be compact.

It is particularly preferred when the gear-step gear set of the first sub-transmission, via which the first electric machine is connected to the first input shaft, is associated with the highest gear step of the first sub-transmission, and/or when the gear-step gear set of the second sub-transmission, via which the second electric machine is connected to the second input shaft, is associated with the highest gear step of the second sub-transmission, and/or when the gear-step gear set of the second sub-transmission, via which the second electric machine is connected to the second input shaft, is the gear set of the two gear sets associated with the one gearshift clutch assembly, which is situated axially farther away from the gearshift clutch plane.

As a result, a good ratio adaptation can be achieved. Moreover, the particular electric machine can then be utilized in the particular sub-transmission in each gear step for synchronization and/or load transfer.

According to one further preferred example embodiment, the gear-step gear set of the first sub-transmission, via which the first electric machine is connected to the first input shaft, is arranged at a first axial end of the transmission arrangement, and/or the gear-step gear set of the second sub-transmission, via which the second electric machine is connected to the second input shaft, is arranged at a second axial end of the transmission arrangement.

This allows for a connection of the electric machine, on the one hand, at the points, at which high bearing forces can be absorbed, since housing walls or bearing plates are generally arranged at the axial ends of the transmission arrangement. Moreover, this allows for a connection of the electric machines in such a way that this connection remains as unaffected as possible from each other. In addition, this type of connection makes it possible for the electric machines to be arranged in axial overlap with each other. It is particularly preferred when the first electric machine and/or the second electric machine extend(s) between the first axial end of the transmission arrangement and the second axial end of the transmission arrangement. As a result, an axially compact design can also be implemented.

Overall, via the transmission arrangement or the hybrid drive train, depending on the example embodiment, at least one of the following advantages is achieved:

low design complexity, since preferably only five (if necessary, six) gear set pairs and four actuating units are to be provided;

good efficiency and a simple configuration result, since, in particular, no winding-path gear steps are implemented;

low component loads result;

at least three electric gear steps result for the first electric machine and at least two gear steps result for the second electric machine;

the transmission arrangement includes preferably only one countershaft, which is preferably connected to a power distribution unit via only one output gear set;

gear change operations can be carried out quickly and efficiently, since an engagement of the dual-clutch assembly is not necessary in an internal combustion engine-driven operation and a hybrid operation and since the synchronization of gear steps is always implementable also by utilizing an electric machine;

a serial operation is implementable with the first electric machine and also with the second electric machine as a generator; and/or

this yields high versatility in combination with compact dimensions.

The two clutches of the dual-clutch assembly can be actuated independently of each other by separate actuating units. It is particularly preferred, however, when the first clutch and the second clutch of the dual-clutch assembly are accommodated in a gearshift clutch assembly, which is actuated by a single actuating unit. Consequently, the gearshift clutch assembly has a first position, in which the first clutch is engaged, a second position, in which the second clutch is engaged, and a third position, in which neither the first clutch nor the second clutch is engaged, i.e., a neutral position.

As mentioned, it is preferred when, in an internal combustion engine-driven operation and in a hybrid operation, one of the two clutches of the dual clutches is always engaged and the other clutch remains disengaged, wherein the third clutch is disengaged or engaged, depending on the gear step.

In order to also be able to disengage, under load, the clutch of the dual-clutch assembly that is always engaged in this case, for example, in the case of an emergency brake application, it can be preferable to implement this clutch of the dual-clutch assembly as a normally disengaged friction clutch. The other clutch, which always remains disengaged in this operation, can still be implemented as a dog clutch.

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawings and are explained in greater detail in the following description, wherein

FIG. 1 shows a diagrammatic gear set representation of an example embodiment of a drive train;

FIG. 2 shows a gearshift table for an operation of the drive train from FIG. 1;

FIG. 3 shows a diagrammatic gear set representation of an example embodiment of a hybrid drive train;

FIG. 4 shows a gearshift table for an internal combustion engine-driven operation and a hybrid operation of the hybrid drive train from FIG. 3;

FIG. 5 shows a gearshift table for an electric motor-driven operation by a first electric machine of the drive train from FIG. 3;

FIG. 6 shows a gearshift table for an electric motor-driven operation by a second electric machine of the drive train from FIG. 3;

FIG. 7 shows a diagrammatic gear set representation of a further example embodiment of a hybrid drive train;

FIG. 8 shows a gearshift table for an internal combustion engine-driven operation and a hybrid operation of the hybrid drive train from FIG. 7;

FIG. 9 shows a gearshift table for an electric motor-driven operation by a first electric machine of the hybrid drive train from FIG. 7;

FIG. 10 shows a gearshift table for an electric motor-driven operation by a second electric machine of the hybrid drive train from FIG. 7; and

FIG. 11 shows a detailed longitudinal sectional representation of one example embodiment of a transmission arrangement.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

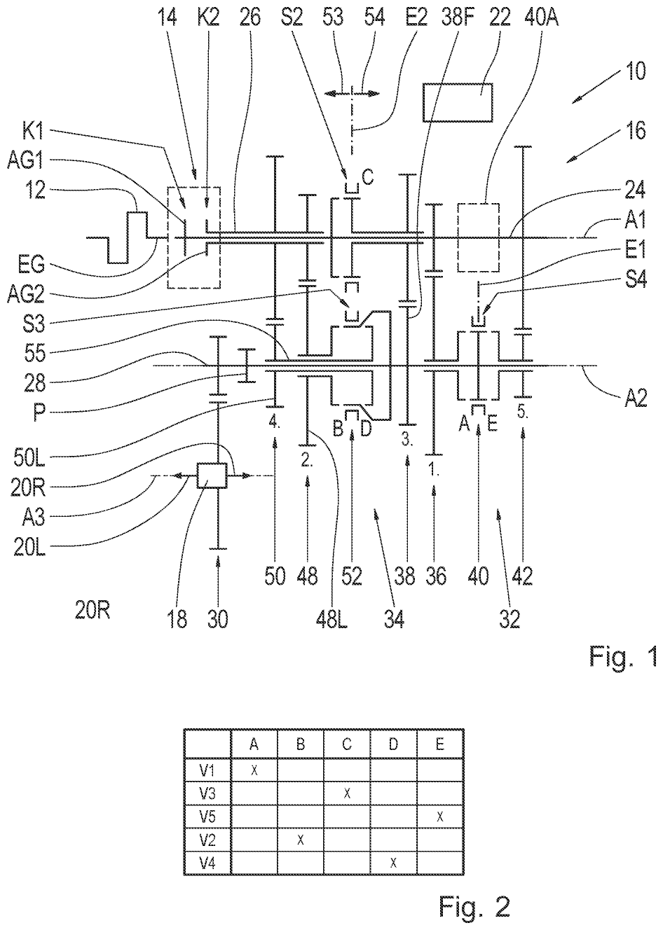

In FIG. 1, a drive train for a motor vehicle, in particular a passenger car, is represented in diagrammatic form and is labeled, in general, with 10.

The drive train 10 includes an internal combustion engine 12, which is connected to an input element of a dual-clutch assembly 14. The dual-clutch assembly 14 is connected on the output side to a transmission arrangement 16. An output of the transmission arrangement 16 is connected to a power distribution unit 18, which can be designed, for example, as a mechanical differential and can distribute the input power to two driven wheels 20L, 20R of the motor vehicle.

Moreover, the drive train 10 includes a control device 22 for controlling all components thereof.

The dual-clutch assembly 14 is arranged on an axis A1, which is coaxial to a crankshaft of the internal combustion engine 12. The dual-clutch assembly 14 can include two friction clutches or one friction clutch and a non-synchronized dog clutch. In the present case, the dual-clutch assembly 14 can also contain two non-synchronized dog clutches K1 and K2. The two clutches K1, K2 have a shared input element EG, which is rotationally fixed to the crankshaft of the internal combustion engine 12. The first clutch K1 has a first output element AG1. The second clutch K2 has a second output element AG2. The output elements AG1, AG2 are arranged coaxially to each other.

The transmission arrangement 16 includes a first input shaft 24 and a second input shaft 26. The input shafts 24, 26 are arranged coaxially to each other and to the axis A1. The first input shaft 24 is designed as an inner shaft. The second input shaft 26 is designed as a hollow shaft.

Moreover, the transmission arrangement 16 includes a countershaft 28, which is designed as an output shaft 28 and is arranged coaxially to a second axis A2. The output shaft 28 is connected via an output gear set 30 to the power distribution unit 18, which is arranged coaxially to an axis A3.

A parking interlock gear P can be rotationally fixed at the output shaft 28 or at an input element of the power distribution unit 18. The drive train 10 can be immobilized by the parking interlock gear P. The associated parking lock device is not represented, for the sake of clarity.

The transmission arrangement 16 has a first sub-transmission 32 and a second sub-transmission 34. The sub-transmissions 32, 34 are arranged axially offset with respect to each other. The first sub-transmission 32 is arranged adjacent to a first axial end of the transmission arrangement 16. The second sub-transmission 34 is arranged adjacent to a second axial end of the transmission arrangement 16, wherein the second axial end is adjacent to the dual-clutch assembly 14. The sub-transmissions 32, 34 have a plurality of engageable gear sets, which, in the engaged condition, each connect an input shaft and the output shaft 28.

The first sub-transmission 32 has a first gear set 36 for the first forward gear step 1 and a second gear set 38 for the third forward gear step 3. The second gear set 38 is arranged closer to the second axial end of the transmission arrangement 16 than the first gear set 36. Moreover, the first sub-transmission 32 has a third gear set 42 for the fifth forward gear step 5. The third gear set 42 is arranged closer to the first axial end of the transmission arrangement 16 than the first gear set 36.

A first gearshift clutch assembly 40 is arranged between the first gear set 36 and the third gear set 42 and, in fact, coaxially to the axis A2. The first gearshift clutch assembly 40 includes a gearshift clutch A for engaging the first gear set 36 and a gearshift clutch E for engaging the third gear set 42. The two gearshift clutches A, E are alternately engageable and are designed as non-synchronized dog clutches. The engagement of a gear set includes the rotationally fixed connection of an idler gear of the particular gear set to an associated shaft. In the present case, for example, the first gear set 36 is engaged, in that an idler gear of the first gear set 36, which is rotatably mounted at the output shaft 28, is rotationally fixed to the output shaft 28, in order to bring the first gear set into the power flow in this way.

The second gear set 38 is engageable with a gearshift clutch C mounted at the input shaft 24 and has an idler gear, which is rotatably mounted at the first input shaft 24.

The second sub-transmission 34 has a fourth gear set 48 for the second forward gear step 2 and a fifth gear set 50 for the fourth forward gear step 4. The fifth gear set 50 is arranged closer to the second axial end than the fourth gear set 48. A second gearshift clutch assembly 52 is arranged on one axial side of the gear sets 48, 50 and, in fact, coaxially to the axis A2. The second gearshift clutch assembly 52 has a gearshift clutch B for engaging the fourth gear set 48 and a gearshift clutch D for engaging the fifth gear set 50. The gearshift clutches B and D are accommodated in the second gearshift clutch assembly 52 in such a way that the gearshift clutches B and D are alternately actuatable.

The first gearshift clutch assembly 40 is situated in a first gearshift clutch plane E1, which is arranged axially between the first gear set 36 and the third gear set 42. The first gearshift clutch assembly 40 is arranged coaxially to the axis A2 in the present case, although the first gearshift clutch assembly 40 could be arranged coaxially to the axis A1, as diagrammatically indicated in FIG. 1 with 40A.

The second gearshift clutch assembly 52 is situated in a second gearshift clutch plane E2, which is arranged axially between the second gear set 38 for the third forward gear step 3 and the fourth gear set 48 for the second forward gear step 2. The gear sets 48, 50 are arranged on a first axial side 53 of the second gearshift clutch plane E2. The gear sets 38, 36, 42 are arranged on a second axial side 54 of the second gearshift clutch plane E2.

The gearshift clutch C, which is utilized for engaging the second gear set 38 for the third forward gear step 3, is arranged axially aligned with the second gearshift clutch assembly 52 in the second gearshift clutch plane E2.

The gearshift clutch C is a single gearshift clutch, which is actuated by a single actuating unit S2. The single gearshift clutch C can also be referred to as a gearshift clutch assembly having only one gearshift clutch. In the present case, the transmission arrangement 16 therefore includes three gearshift clutch assemblies 40, 52, C, which are actuatable by three actuating units S2, S3, S4. The gearshift clutch assembly having the gearshift clutch C is actuatable by an actuating unit S2. The second gearshift clutch assembly 52 having the gearshift clutches B and D is actuatable by an actuating unit S3. The first gearshift clutch assembly 40 is actuatable by an actuating unit S4.

While the first gearshift clutch assembly 40 is usually arranged axially between the two associated gear sets 36, 42, as is also the case, for example, with the first gearshift clutch assembly 40, the second gearshift clutch assembly 52 is designed, in the present case, in such a way that the second gearshift clutch assembly 52 is associated with two gear sets 48, 50, which are arranged on one axial side, namely the first axial side 53, of the gearshift clutch plane E2.

For this purpose, a connecting shaft 55 is associated with the second gearshift clutch assembly 52. The connecting shaft 55 is arranged, as a hollow shaft, around the output shaft 28. An idler gear 50L of the fifth gear set 50 is rotationally fixed to the connecting shaft 55. An idler gear 48L of the fourth gear set 48 is rotatably mounted at an outer circumference of the connecting shaft 55. The connecting shaft 55 extends axially from the idler gear 50L through the idler gear 48L to the second axial side 54 of the second gearshift clutch plane E2.

The gearshift clutch D for engaging the fifth gear set 50 faces the second axial side 54 of the gearshift clutch plane E2, while the gearshift clutch B for engaging the fourth gear set 48 faces the first axial side 53 of the gearshift clutch plane E2.

The transmission arrangement 16 has two gearshift clutch planes E1, E2 and five gear set planes, and so an axially compact design is implemented.

More precisely, the transmission arrangement 16 therefore has five gear set planes, starting from the second axial end toward the first axial end, in the following order: gear set 50 for the fourth forward gear step 4, gear set 48 for the second forward gear step 2, gear set 38 for the third forward gear step 3, gear set 36 for the first forward gear step 1, and gear set 42 for the fifth forward gear step 5.

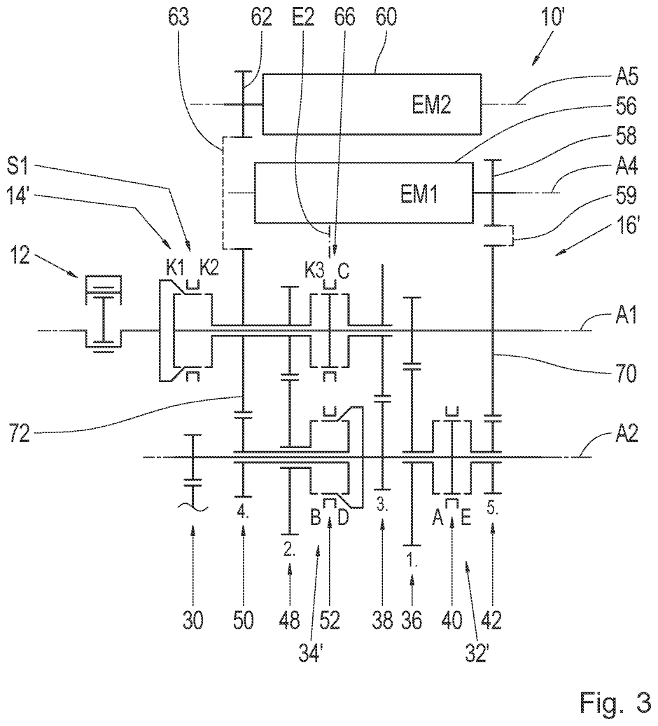

The transmission arrangement 16 can include a first electric machine and/or a second electric machine, as described in the following with reference to FIGS. 3 through 6 or 7 through 10. Consequently, the transmission arrangement 16 can be designed as a normal transmission arrangement or as a hybrid transmission arrangement.

As indicated in the gearshift table from FIG. 2, in order to engage a forward gear step V1, the gearshift clutch A is engaged and all other gearshift clutches B, C, D, and E are disengaged.

In a corresponding way, in order to engage the forward gear step V2, the gearshift clutch B is engaged and all other gearshift clutches are disengaged.

In a corresponding way, the gearshift clutch C is engaged in the forward gear step V3. In the forward gear step V4, the gearshift clutch D is engaged. In the forward gear step V5, the gearshift clutch E is engaged.

The transmission arrangement 16 is a basic transmission arrangement. Provided the transmission arrangement 16 is not designed as a hybrid transmission arrangement and no electric motor-generated input power is otherwise provided, for example, at the input element EG, it is preferred when either one of the aforementioned gear sets or a further gear set is provided for establishing a reverse gear step. When at least one electric prime mover is provided, this type of reverse gear-gear set can be dispensed with, however.

The transmission arrangement 16 can be operated in the manner of a dual-clutch transmission, wherein one of the two sub-transmissions 32, 34 is an active sub-transmission in each case, via which input power is transmitted. In the sub-transmission that is then inactive, a connecting gear step can be preselected. Gear changes then take place by an overlapping actuation of the two clutches K1, K2 of the dual-clutch assembly, which can be preferably designed as friction clutches in this case.

For the case in which the clutches K1, K2 are designed as dog clutches, it is preferred when the transmission arrangement 16 includes at least one electric machine, in order to be able to support powershifts and avoid an interruption of tractive force.

In the following FIGS. 3 through 10, further example embodiments of drive trains and transmission arrangements are shown, which generally correspond to the drive train and the transmission arrangement from FIG. 1 with regard to configuration and mode of operation. Identical elements are therefore labeled with identical reference characters. In the following, essentially, the differences are explained.

The drive train 10′ from FIG. 3 is designed as a hybrid drive train and includes a first electric machine 56, which is arranged coaxially to a fourth axis A4. The first electric machine 56 has a first pinion 58, which is rotationally fixed to a rotor of the first electric machine 56 and is coaxial to the axis A4. The first pinion 58, which can also be referred to as the first machine pinion, is connected to a gear-step gear set of the first sub-transmission 32′, in the present case to the third gear set 42 for the forward gear step 5, via a first intermediate gear 59, which is rotatably mounted at an axle (not described in greater detail). More precisely, the first pinion 58 meshes with the first intermediate gear 59, and the first intermediate gear 59 meshes with a fixed gear of the third gear set 42, wherein the fixed gear is rotationally fixed to the first input shaft 24.

Moreover, the hybrid drive train 10′ has a second electric machine 60, which is arranged axially parallel to the input shafts 24, 26 and, in fact, coaxially to a fifth axis A5. The second electric machine has a second pinion (second machine pinion) 62, which is arranged coaxially to the axis A5. The second pinion 62 is connected to the second input shaft 26 via a gear-step gear set of the second sub-transmission 34′. In the present case, the second pinion 62 is connected to the fifth gear set 50 for the fourth forward gear step 4 via a second intermediate gear 63. More precisely, the second pinion 62 meshes with the second intermediate gear 63, which is rotatably mounted at an axle (not described in greater detail), and the second intermediate gear 63 meshes with a fixed gear of the fifth gear set 50, wherein the fixed gear is rotationally fixed to the second input shaft 26.

The five axes A1, A2, A3, A4, A5 are all aligned in parallel with one another.

The dual-clutch assembly 14′ is arranged adjacent to the second axial end of the transmission arrangement 16, as mentioned above. The output gear set 30 is also arranged on the second axial side of the transmission arrangement 16 and is preferably axially aligned with the dual-clutch assembly 14′ or is situated approximately in a plane therewith. The parking interlock gear P can be fixed at the output shaft 28 between the output gear set 30 and the fifth gear set 50.

In the hybrid drive train 10′, the electric machines 56, 60 are each connected to a gear-step gear set of a respective associated sub-transmission of the electric machines 56, 60, which is associated with the highest gear step of that sub-transmission. Moreover, the electric machines 56, 60 are each connected via a gear-step gear set to the respective particular sub-transmission, which is preferably arranged adjacent to an axial end of the transmission arrangement. The gear sets are situated at opposite axial ends.

The electric machines 56, 60 are arranged in axial overlap with each other. Due to the connection via intermediate gears 59, 63, high ratios for the particular gear-step gear sets can be established, and so relatively high-speed electric machines can be utilized, which are compact.

The hybrid transmission arrangement in the present case has precisely five forward gear steps and does not have a reverse gear step. An operation in reverse can be exclusively established through the hybrid drive train 10′ when one of the electric machines 56 or 60 is driven in the opposite direction of rotation.

The transmission arrangement 16′ has no winding-path gear steps. Each gear set 36 through 50 includes precisely one idler gear and one fixed gear, wherein the idler gears of the gear sets 36, 42, 48, 50 are rotatably mounted at the output shaft 28, and wherein the idler gear of the gear set 42 is rotatably mounted at the first input shaft 24.

Moreover, the hybrid drive train 10′ includes a third clutch K3, which can also be referred to as a bridge clutch.

The third clutch K3 is utilized for connecting the first input shaft 24 and the second input shaft 26. The third clutch K3 is arranged adjacent to the fourth gear set 48 for the forward gear step 2 and, with the gearshift clutch C for the second gear set 38 for engaging the third forward gear step, forms a third gearshift clutch assembly 66. The third clutch K3 is implemented similarly to the gearshift clutches A, B, C, D, E, as a non-synchronized dog clutch.

The third gearshift clutch assembly 66 is arranged coaxially to the first axis Al and, in fact, between the gear sets 42, 48.

The third gearshift clutch assembly 66, as well as the second gearshift clutch assembly 52, is situated in the second gearshift clutch plane E2. The third gearshift clutch assembly 66 is actuated by a single actuating unit S2, even though this is not represented in greater detail in FIG. 3.

The dual-clutch assembly 14′ of the hybrid drive train 10′ is designed as a dual-clutch assembly, in which the two clutches K1, K2 are designed as dog clutches and form a gearshift clutch assembly, which is actuatable by a single actuating unit S1. Consequently, the clutches K1 and K2 are alternately engageable.

The dual-clutch assembly 14′ and the three gearshift clutch assemblies 40, 52, 66 are actuatable by four actuating units S1 through S4.

It is apparent that input power from the internal combustion engine 12 can be guided either via the clutch K1 to the first sub-transmission 32′ or via the clutch K2 to the second sub-transmission 34′. Input power of the first electric machine 56 can be supplied directly into the first sub-transmission 32′ or, via the clutch K1, toward the internal combustion engine 12 (for example, in order to start the internal combustion engine 12).

Input power of the second electric machine 60 can be introduced directly into the second sub-transmission 34′ or, via the clutch K2, to the internal combustion engine 12, for example, in order to start the internal combustion engine 12.

Moreover, it is apparent that the first sub-transmission 32′ and the second sub-transmission 34′ are connectable to each other via the third clutch K3, and so, for example, when the clutch K1 is engaged, internal combustion engine-generated power can flow via the clutch K3 to the second sub-transmission 34′.

In this case, the first electric machine 56 can be switched to idle, and so the first electric machine 56 rotates in a nearly loss-free manner, or can be operated as a generator or as an electric motor.

In a corresponding way, when the clutch K2 is engaged, power of the internal combustion engine 12 can be directed to the first sub-transmission 32′ when the clutch K3 is engaged.

Moreover, a serial operation is possible when, for example, purely electric motor-generated input power from the first electric machine 56 is guided via the first sub-transmission 32′ to the output shaft 28. In this case, when the clutches K1 and K3 are disengaged, the clutch K2 can be engaged, in order to utilize input power of the internal combustion engine 12 to drive the second electric machine 60, in order to allow the second electric machine 60 to operate as a generator, which charges a battery (not represented in greater detail) of the drive train 10′. It is understood that all gearshift clutches of the second sub-transmission 34′ are disengaged in this case.

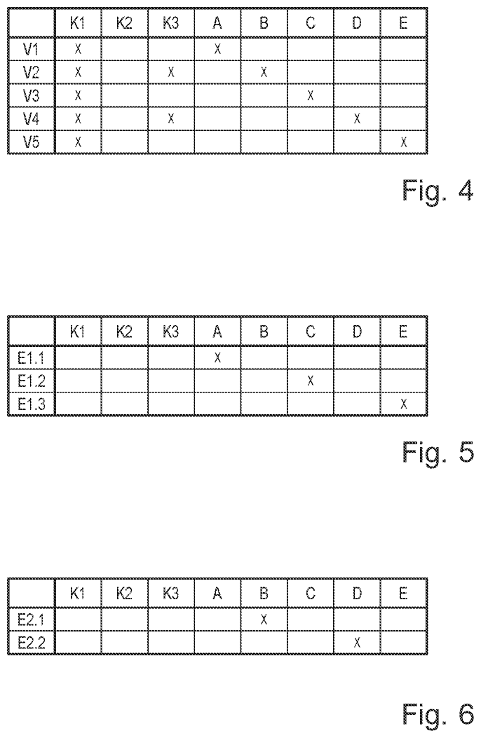

Different operations, which are establishable with the hybrid drive train 10′ from FIG. 3, are explained with reference to FIGS. 4 through 6.

FIG. 4 shows a gearshift table of the shift elements K1, K2, K3, A, B, C, D, E in a purely internal combustion engine-driven operation or in a hybrid operation, in which input power is made available by the internal combustion engine 12 and, optionally, by the electric motors 56, 60.

In all forward gear steps V1 through V5 establishable in this operation, the first clutch K1 is continuously engaged and the second clutch K2 of the dual-clutch assembly 14 is continuously disengaged. In the forward gear step V1, the gearshift clutch A is engaged and all other gearshift clutches B through E are disengaged. The third clutch K3 is also disengaged. Consequently, power flows from the internal combustion engine via the first clutch K1 and the first input shaft 24 to the first gear set 36 and, from there, via the gearshift clutch A to the output shaft 28.

It is understood that a driving start from a standstill generally takes place purely via electric motors until a speed is reached, at which the internal combustion engine 12 can be connected via the clutch K1, i.e., at a speed that corresponds to a rotational speed above the idling speed of the internal combustion engine 12. Consequently, a driving start from a standstill takes place, for example, via the first electric machine 56 and the gear set 36 for the first forward gear step 1. As soon as a speed has been reached that corresponds to the speed of the internal combustion engine 12, the clutch K1 can be engaged. The clutch K1 remains engaged during the entire internal combustion engine-driven operation.

A changeover from the forward gear step V1 into the forward gear step V2 is initially prepared; the gearshift clutch B for the forward gear step V2 is engaged. This can take place, if necessary, with the aid of a synchronization by the second electric machine 16.

Thereafter, the gearshift clutch A for the forward gear step V1 is disengaged, wherein the tractive force is supported by the second electric machine 60 and the already engaged gear set 48 for the forward gear step V2. Thereafter, the third clutch K3 can be engaged, wherein the synchronization necessary therefor takes place, on the one hand, by a rotational-speed adaptation of the internal combustion engine 12, but also by appropriate synchronization measures of the second electric machine 60. In the second forward gear step, consequently, power flows from the internal combustion engine 12 via the first clutch K1, the first input shaft 24, the engaged third clutch K3, the second input shaft 26, and the gear set 48 for the second forward gear step V2, which is engaged via the gearshift clutch B, to the output shaft 28.

During the changeover into the forward gear step V3, the third clutch K3 is disengaged, the tractive force is supported via the second electric machine 60 and, thereafter, the connecting gear step 3 can be engaged in the first sub-transmission 32 by engaging the gearshift clutch C. The necessary synchronization can take place by the first electric machine 56.

Thereafter, the load can be supported by the first electric machine 56 and the gearshift clutch B of the forward gear step 2 can be disengaged.

The further gear changes from the gear steps V3 to V4 and from V4 to V5 result in a corresponding way. In both of the even forward gear steps V2 and V4, the third gearshift clutch K3 is engaged. The second clutch K2 is always disengaged and the first clutch K1 is always engaged.

In FIG. 5, a purely electric motor-driven operation by means of the first electric machine is represented. In a first electric gear step E1.1, only the gearshift clutch A for the forward gear step 1 is engaged. In a second electric forward gear step E1.2, only the gearshift clutch C is engaged. In a third electric-motor gear step E1.3, the gearshift clutch E is engaged.

In a corresponding way, FIG. 6 shows a purely electric motor-driven operation by the second electric machine 60. In a first gear step E2.1, only the gearshift clutch B is engaged. In a second electric gear step E2.2, only the gearshift clutch D is engaged.

In the purely electric operation according to FIGS. 5 and 6, purely electric powershifts (i.e., gear changes between forward gear steps without or with reduced interruption of tractive force) are possible. Here, an electric motor-driven operation is established exclusively, for example, between the gear steps E1.1, E1.2, E1.3 or exclusively between the gear steps E2.1 and E2.2, and a gear change takes place while the other electric machine maintains the tractive force.

During a gear change, for example, from the forward gear step E1.1 into the forward gear step E1.2, the gearshift clutch B can be engaged in the second sub-transmission and, consequently, the second electric machine can maintain the tractive force during the gear change in the first sub-transmission.

In the purely internal combustion engine-driven operation or hybrid operation (i.e., for the case in which internal combustion engine-generated power and, optionally, electric motor-generated power are guided to the output shaft), it is advantageous that the first clutch K1 is utilized for connecting the internal combustion engine 12 to the first input shaft 24 and, consequently, always supplying internal combustion engine-generated power into the transmission arrangement 16 via the first input shaft 24. Consequently, the first electric machine 56 associated with the first sub-transmission 32 is always rotationally fixed to the internal combustion engine 12 during this operation. As a result, it is possible to establish load-point displacements at the internal combustion engine 12, and the first electric machine 56 can provide assistance during the closed-loop control of the rotational speed when a synchronization process is to take place. In other words, since the first clutch K1 always remains engaged, the first electric machine 56 can assist the internal combustion engine 12 during synchronization.

In order to integrate the third clutch K3, which is necessary therefor, into the transmission arrangement as efficiently as possible, the third clutch K3 is accommodated in the third gearshift clutch assembly 66. Since the third clutch K3 is therefore integrated with a gearshift clutch into a gearshift clutch assembly that is associated with that sub-transmission, the associated clutch K1—of the dual-clutch assembly 14—of which is always engaged in the internal combustion engine-driven or hybrid operation, the internal combustion engine 12 can utilize all gear steps of the transmission.

The second clutch K2 is preferably engaged only when a serial operation is established. Here, the first clutch K1 is disengaged. Via the first sub-transmission 32 and the first electric machine 56, a purely electric motor-driven operation is established in a gear step, for example, in the forward gear step 1. The internal combustion engine 12 drives the second electric machine 60 via the engaged second clutch K2 and drives the second electric machine 60 as a generator, and so the power withdrawn from a vehicle battery by the first electric machine 56 in this purely electric operation can be simultaneously resupplied, at least partially, via the second electric machine 60.

A serial operation of this type is also possible in reverse when travel takes place purely electrically by the second electric machine 60 and the internal combustion engine 12 drives the first electric machine 56. In the latter case, the first clutch K1 is engaged and the second clutch K2 is disengaged.

The serial operation is utilized, in particular, in a crawling mode, in which the vehicle speed is lower than a minimum speed that is establishable by the internal combustion engine 12.

The sub-transmission 32 that is associated with the clutch K1, which is always engaged in the internal combustion engine-driven mode, preferably also includes the highest forward gear step of the transmission arrangement 16. As a result, when the third clutch is disengaged, the second electric machine 60 can be practically decoupled, in order to avoid drag losses. In addition, the first electric machine 56 can remain coupled, in order to supply the main power circuit with electrical energy (operation as a generator), or in order to establish a boost operation (operation as a motor).

During a gear shift from a forward gear step of the first sub-transmission 32 into a forward gear step of the second sub-transmission 34, the desired gear step is initially engaged in the second sub-transmission by engaging the associated gearshift clutch (D or B). This takes place with the aid of a synchronization by the second electric machine 60, wherein the second electric machine switches over, in a load-free manner, into this target gear step in the second sub-transmission 34. Thereafter, the second electric machine 60 supports the tractive force during the gear shift via the already engaged target gear step. During the gear shift, initially the gearshift clutch of the first sub-transmission, which is associated with the starting or source gear step, disengages and, thereafter, the third clutch K3 is engaged, wherein the internal combustion engine 12 and the first electric machine 56 interact during the synchronization.

During a gear shift from the second sub-transmission 34 into a gear step of the first sub-transmission 32, the second electric machine 60 initially supports the tractive force in the source gear step or the actual gear during the gear shift. During the gear shift, the third clutch K3 is initially disengaged and one of the shift elements A, C, E engages, wherein the internal combustion engine 12 and the first electric machine 56 interact during the necessary synchronization. After the disengagement of the third clutch K3 and the load transfer on the first sub-transmission 32, the output gear step (actual gear step) in the second sub-transmission is disengaged.

It is understood that a stationary charging can also take place with the hybrid drive train when the vehicle is at a standstill. For example, the first clutch K1 can be engaged and input power of the internal combustion engine is supplied via the first input shaft 24 into the first electric machine 56. The second clutch K2 remains disengaged and the gearshift clutches A, C, E of the first sub-transmission 32 also remain disengaged. Therefore, the first sub-transmission 32 remains in neutral. In this condition, as mentioned, a stationary charging can take place, but a start of the internal combustion engine 12 by the first electric machine 56 can also take place.

In general, it is also conceivable to engage both clutches K1 and K2 or to engage the clutch K1 and the clutch K3, in order to allow a charging process to take place with the first electric machine 56 and also with the second electric machine 60. In this case, the internal combustion engine 12 drives both electric machines 56, 60 and both electric machines 56, 60 operate as generators, in order to charge a vehicle battery.

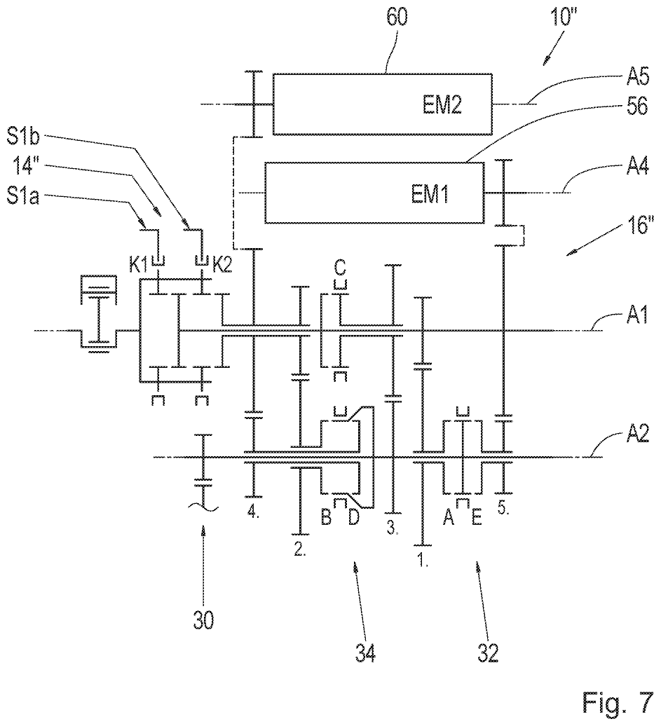

In FIG. 7, a further example embodiment of a hybrid drive train 10″ with a hybrid transmission arrangement 16″ is shown, wherein the hybrid drive train 10″ generally corresponds to the drive train 10 from FIG. 1 with respect to configuration and mode of operation. In addition, the transmission arrangement 16″ includes a first electric machine 56 and a second electric machine 60, which are connected in the same manner as in the drive train 10′ from FIG. 3.

In contrast to the drive train from FIG. 3, the hybrid drive train 10″ does not have a third clutch K3. The two clutches K1, K2 of a dual-clutch assembly 14″ are designed as dog clutches, which are actuatable by actuating units S1a and S1b that are separate and activatable independently of each other.

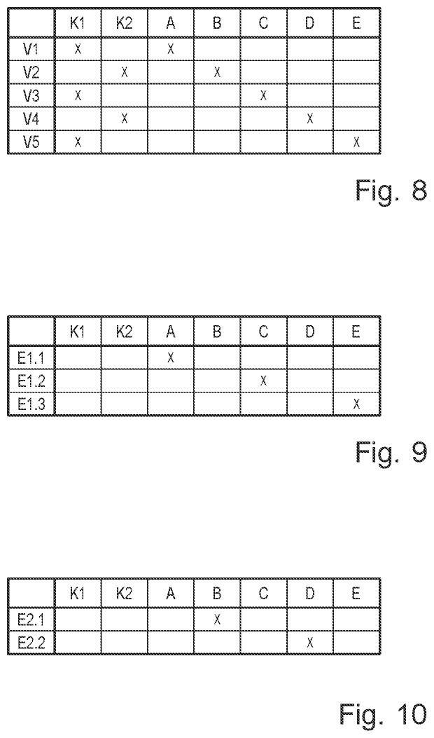

Different operations, which are establishable with the hybrid drive train 10″ from FIG. 7, are explained with reference to FIGS. 8 through 10.

It is apparent (FIG. 8) that, in contrast to the drive train 10′ from FIG. 3, due to the absence of the third clutch K3, gear changes always take place in such a way that the first clutch K1 and the second clutch K2 are alternately engaged. The functionality corresponds to that of a conventional dual-clutch transmission, wherein one of the gearshift clutches A through E is engaged in each case, in order to establish the particular forward gear steps.

A synchronization and load transfer can take place by the electric machines 56, 60 in a similar manner, as has been described with reference to FIGS. 3 through 6.

FIGS. 9 and 10 are identical to FIGS. 5 and 6 and show the electric motor-driven operation by means of the hybrid drive train 10″ by utilizing the first electric machine (FIG. 9) or the second electric machine (FIG. 10).

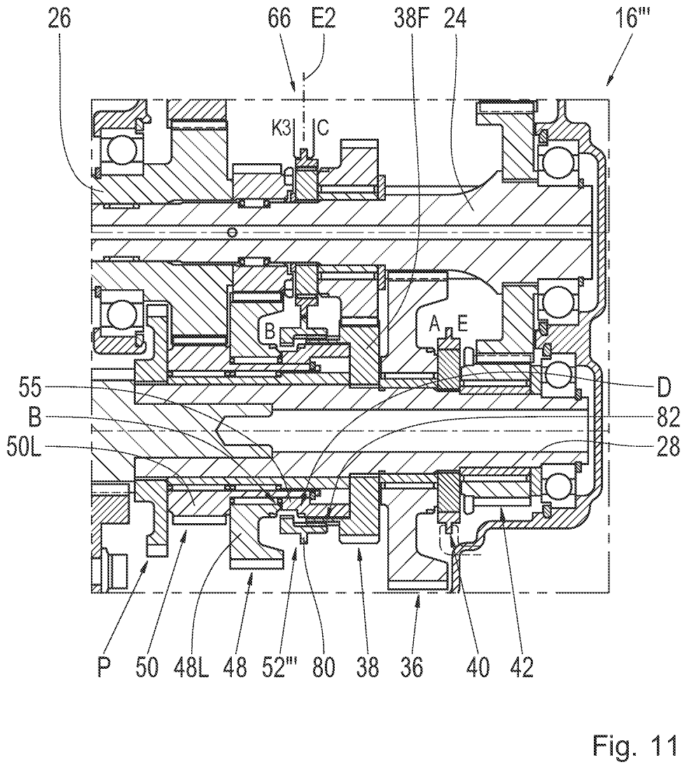

FIG. 11 shows a detailed longitudinal sectional view through one further example embodiment of a transmission arrangement 16′″.

In FIG. 11, in particular, the second gearshift clutch assembly 52′″ is represented, which generally corresponds to the second gearshift clutch assembly 52 from FIGS. 1, 3, and 7 with respect to configuration and mode of operation. Identical elements are therefore labeled with identical reference characters.

In FIG. 11, it is apparent that the second gear set 38 includes a fixed gear 38F, which is rotationally fixed to the output shaft 28.

The fixed gear 38F has an axial projection 82 pointing in the axial direction toward the second gearshift clutch plane E2, on the axially toothed outer circumference of which a sliding element 80 is axially displaceably mounted. The sliding element 80 is actuatable by a single actuating unit S3. The sliding element 80 has an axial spline on an inner circumference of the sliding element 80.

The idler gear 48L has, on an axial projection in the manner of a clutch body, an external toothing, onto which the internal toothing of the sliding element 80 can be slid, in order to engage the gearshift clutch B.

On the other hand, an element rotationally fixed to the connecting shaft 55 includes a section having an external toothing, onto which the internal toothing of the sliding element 80 can be alternatively slid, in order to engage the gearshift clutch D.

In FIG. 11, the sliding element 80 is shown in a neutral position, in which the toothing of the sliding element 80 does not engage into the toothing of the idler gear 48L or into the toothing of the connecting shaft 55.

As represented in FIG. 11, the connecting shaft 55 can be implemented in the form of an axial projection of the idler gear 50L and a shaft section fixed on the opposite side of the idler gear 48L, which is rotationally fixed to the idler gear 50L.

The second gearshift clutch assembly 52′″ from FIG. 11 is usable in each of the transmission arrangements 16, 16′, and 16″ from FIGS. 1, 3, and 7.

In all example transmission arrangements from FIGS. 1, 3, and 7, the gear sets for the forward gear steps 3 and 5 can also be interchanged with one another. In this case, the third gearshift clutch assembly 66 would include the gearshift clutch E for the forward gear step 5.

As described above, the electric machines 56, 60 are each connected at a gear-step gear set of the particular sub-transmission. The third gear set 42 includes a fixed gear 70, which is in engagement with the intermediate gear 59. The fifth gear set 50 includes a fixed gear 72, which is in engagement with the intermediate gear 63.

Alternatively, it is also conceivable to connect at least one of the electric machines 56, 60 to the particular input shaft via a separate gear set. In this case, the fixed gears 70, 72 could be designed as separate fixed gears, which are not assigned to any gear-step gear set. As a result, an additional degree of freedom can be achieved, which simplifies the implementation of the pre-ratio.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid drive train
12 internal combustion engine
14 dual-clutch assembly
16 transmission arrangement
18 power distribution unit
20 driven wheels
22 control device
24 first input shaft
26 second input shaft
28 output shaft
30 output gear set
32 first sub-transmission
34 second sub-transmission
36 gear set (1)
38 gear set (3)
40 first gearshift clutch assembly
42 gear set (5)
48 gear set (2)
50 gear set (4)
52 second gearshift clutch assembly (gearshift clutch assembly)
53 1st axial side of E2
54 2nd axial side of E2
55 connecting shaft
56 first electric machine
58 first machine pinion
59 first intermediate gear
60 second electric machine
62 second machine pinion
63 second intermediate gear
66 third gearshift clutch assembly (further gearshift clutch assembly)
first machine gearwheel
second machine gearwheel
sliding element
projection (at idler gear of 38)
A1-A5 axes A-E gearshift clutches for gear steps
E1-E2 gearshift clutch planes
K1, K2 clutches of dual-clutch assembly
EG input element
K3 bridge clutch
S1-S4 actuating units
P parking interlock gear

1-12. (canceled)

13. A transmission arrangement (16) for a motor vehicle drive train (10), comprising:
a first shaft arrangement (24, 26) and a second shaft arrangement (28);
a plurality of engageable gear sets (36, 38, 42, 48, 50), which connect the first shaft arrangement (24, 26) and the second shaft arrangement (28) in order to establish at least one appropriate plurality of gear steps (1-5); and
at least three gearshift clutches (B, D, C) for engaging at least some (38, 48, 50) of the plurality of engageable gear sets (36, 38, 42, 48, 50),
wherein two (B, D) of the at least three gearshift clutches (B, D, C) form a gearshift clutch assembly (52) arranged at one (28) of the first and second shaft arrangements (24, 26; 28),
wherein one gearshift clutch (C) of the at least three gearshift clutches (B, D, C) is arranged at the other one (24, 26) of the first and second shaft arrangements (24, 26; 28) and is arranged in a gearshift clutch plane (E2) with the gearshift clutch assembly (52), and
wherein the gear sets (48, 50) of the plurality of engageable gear sets (36, 38, 42, 48, 50) associated with the two gearshift clutches (B, D) of the gearshift clutch assembly (52) are arranged on a first axial side (53) of the gearshift clutch plane (E2).

14. The transmission arrangement of claim 13, wherein the gear set (38) of the plurality of engageable gear sets (36, 38, 42, 48, 50) associated with the one gearshift clutch (C) is arranged on a second axial side (54) of the gearshift clutch plane (E2).

15. The transmission arrangement of claim 13, wherein:
two gear sets (48, 50) of the plurality of engageable gear sets (36, 38, 42, 48, 50) are arranged on the first axial side (53) of the gearshift clutch plane (E2);
the one (50) of the two gear sets (48, 50) that is situated axially farther away from the gearshift clutch plane (E2) comprises an idler gear (50L) rotationally fixed to a connecting shaft (55);
an idler gear (48L) of the other (48) of the two gear sets (48, 50) is rotatably mounted to the connecting shaft (55); and
the idler gear (48L) of the other (48) of the two gear sets (48, 50) is disposed axially closer to the gearshift clutch plane (E2) than the idler gear (50L) of the one (50) of the two gear sets (48, 50).

16. The transmission arrangement of claim 13, wherein a sliding element (80) of the gearshift clutch assembly (52) is axially displaceably mounted at an axial projection (82) of a fixed gear (38F) of one (38) of the plurality of engageable gear sets (36, 38, 42, 48, 50) arranged on a second axial side (54) of the gearshift clutch plane (E2).

17. The transmission arrangement of claim 13, wherein:
the first shaft arrangement comprises an input shaft arrangement (24, 26) with a first input shaft (24) of a first sub-transmission (32) of the transmission arrangement (16) and a second input shaft (26), the second input shaft (26) is mounted concentrically to the first input shaft (24), of a second sub-transmission (34); and/or
the second shaft arrangement is a single output shaft (28).

18. The transmission arrangement of claim 17, further comprising one or both of a first electric machine (56) and a second electric machine (60), the first electric machine (56) connected to the first input shaft (24), the second electric machine (60) connected to the second input shaft (26).

19. The transmission arrangement of claim 18, wherein one or both of:
the first electric machine (56) is connected to the first input shaft (24) via a gear-step gear set (42′) of the first sub-transmission (32); and
the second electric machine (60) is connected to the second input shaft (26) via a gear-step gear set (50) of the second sub-transmission (34).

20. The transmission arrangement of claim 19, wherein one or more of:
the gear-step gear set (42) of the first sub-transmission (32) is associated with the highest gear step (5) of the first sub-transmission (32);
the gear-step gear set (50) of the second sub-transmission (34) is associated with the highest gear step (4) of the second sub-transmission (34); and
the gear-step gear set (50) of the second sub-transmission (34) is the one (50) of the two gear sets (48, 50) that is situated axially farther away from the gearshift clutch plane (E2).

21. The transmission arrangement of claim 19, wherein one or both of:
the gear-step gear set (42) of the first sub-transmission (32) is arranged at a first axial end of the transmission arrangement (16); and
the gear-step gear set (50) of the second sub-transmission (34) is arranged at a second axial end of the transmission arrangement (16).

22. The transmission arrangement of claim 13, further comprising a third clutch (K3) configured for selectively connecting a first sub-transmission (32) and a second sub-transmission (34), the third clutch (K3) forming a further gearshift clutch assembly (66) with the one gearshift clutch (C) arranged at the other one (24, 26) of the first and second shaft arrangements (24, 26; 28).

23. The transmission arrangement of claim 22, further comprising one or both of a first electric machine (56) and a second electric machine (60), the first electric machine (56) connected to the first input shaft (24), the second electric machine (60) connected to the second input shaft (26).

24. The transmission arrangement of claim 23, wherein one or both of:
the first electric machine (56) is connected to the first input shaft (24) via a gear-step gear set (42′) of the first sub-transmission (32); and
the second electric machine (60) is connected to the second input shaft (26) via a gear-step gear set (50) of the second sub-transmission (34).

25. The transmission arrangement of claim 24, wherein one or more of:
the gear-step gear set (42) of the first sub-transmission (32) is associated with the highest gear step (5) of the first sub-transmission (32);
the gear-step gear set (50) of the second sub-transmission (34) is associated with the highest gear step (4) of the second sub-transmission (34); and
the gear-step gear set (50) of the second sub-transmission (34) is the one (50) of the two gear sets (48, 50) that is situated axially farther away from the gearshift clutch plane (E2).

26. The transmission arrangement of claim 24, wherein one or both of:
the gear-step gear set (42) of the first sub-transmission (32) is arranged at a first axial end of the transmission arrangement (16); and
the gear-step gear set (50) of the second sub-transmission (34) is arranged at a second axial end of the transmission arrangement (16).

27. A drive train (10) for a motor vehicle, comprising:
a dual-clutch assembly (14) that comprises a first clutch (K1) and a second clutch (K2); and
the transmission arrangement (16) of claim 13,
wherein the first clutch (K1) is associated with a first sub-transmission (32) of the transmission arrangement (16), and
wherein the second clutch (K2) is associated with a second sub-transmission (34) of the transmission arrangement (16).

28. A method for operating a drive train of claim 27, comprising
in an internal combustion engine-driven operation or a hybrid operation, implementing the odd gear steps (1, 3, 5) of the first sub-transmission (32) by engaging the first clutch (K1) of the dual-clutch assembly (14); and
implementing the even gear steps (2, 4) of the second sub-transmission (34) by engaging the first clutch (K1) and a third clutch (K3),
wherein the third clutch (K3) is configured to selectively connect the first sub-transmission (32) and the second sub-transmission (34).
